(19) United States
(12) Patent Application Publication
(10) Pub. No.: US 2006/0086809 A1
(43) Pub. Date: Apr. 27, 2006

(54) Method, system, and apparatus for a radio frequency identification (RFID) waveguide for reading items in a stack

(75) Inventors: Wayne E. Shanks, Baltimore, MD (US); William McKinzie, Fulton, MD (US)

Correspondence Address: STERNE, KESSLER, GOLDSTEIN & FOX PLLC, 1100 NEW YORK AVENUE, N.W., WASHINGTON, DC, 20005, US

(73) Assignee: Symbol Technologies, Inc., Holtsville, NY (US)

(21) Appl. No.: 11/155,894

(22) Filed: Jun. 20, 2005

Related U.S. Application Data
(60) Provisional application No. 60/580,386, filed on Jun. 18, 2004.

(51) Int. Cl. G06K 19/06; G06F 7/00; G06Q 30/00; G08B 13/14

(52) U.S. Cl. 235/492; 340/572.7; 235/385; 700/215

(57) ABSTRACT

A method, system, and apparatus for reading RFID tags in a stack of objects is described. For example, a pallet may hold a stack of objects, with one or more of the objects coupled to a RFID tag. A RFID reader may be used to read the tags in the stack. However, tagged objects in the middle of the stack may be difficult to read due to the RF signal loss passing through objects in the stack. A waveguide may be used to guide radio waves to locations in the pallet stack. For example, the waveguide can replace a slipsheet that is conventionally placed between horizontal layers of cases in the pallet stack.

### CROSS-REFERENCE TO RELATED APPLICATION

This application claims the benefit of U.S. Provisional Application No. 60/580,386, filed Jun. 18, 2004 (Atty. Dkt. No. 1689.0620000), which is incorporated herein by reference in its entirety.

### BACKGROUND OF THE INVENTION

1. Field of the Invention

The present invention relates to radio frequency identification (RFID) tag and reader technology.

2. Background Art

An RFID tag may be affixed to an item whose presence is to be detected and/or monitored. The presence of an RFID tag, and therefore the presence of the item to which the tag is affixed, may be checked and monitored by devices known as “readers.”

Difficulties are encountered when attempting to read RFID tags that are blocked by objects from unimpeded, direct access by a reader. For example, difficulties are encountered when reading tags in a stack of items. A pallet may hold a stack of objects, with one or more of the objects coupled to a RFID tag. A RFID reader may be used to read the tags in the stack. However, tagged objects in the middle of the stack may be difficult to read due to the RF signal loss passing through objects in the stack.

Thus, it would be desirable to be able to read RFID tags that are in a stack of objects, or are otherwise difficult to read due to being blocked from direct access by a reader.

### BRIEF SUMMARY OF THE INVENTION

Methods, systems, and apparatuses are described for a radio frequency identification (RFID) waveguide for reading items in a stack.

According to an embodiment, a waveguide is provided between objects in a stack of objects to facilitate communication between an RFID reader and a tag that is attached to an object in the stack. For example, an RF signal may propagate along the waveguide to the tag. The waveguide may be any of a variety of waveguides, such as a transverse electric (TE) mode surface waveguide, a transverse electromagnetic (TEM) mode surface waveguide, a transverse magnetic (TM) mode surface waveguide, a parallel plate waveguide, or an electromagnetic hard surface. The waveguide may have an edge portion that extends beyond an outer perimeter of the stack. The waveguide may be arranged in any configuration with reference to the stack (e.g., vertically, horizontally, etc.).

Slots may be provided in the waveguide to facilitate the transfer of the RF signal to and/or from the waveguide. The waveguide may include tapered metallic elements to facilitate transferring energy of the RF signal to the waveguide. The profile and/or mass of the waveguide may be reduced by implementing a capacitive element in the waveguide. The waveguide may include interdigital capacitors or overlay capacitors, to provide some examples.

In another embodiment, a method is provided in which a first radio frequency (RF) signal is transmitted along a waveguide that is provided between objects in a stack of objects. The first RF signal may be provided to the waveguide by a tag reader, for example. Tapered metallic elements along an edge of the waveguide may receive the first RF signal for transmission to the tag. The first RF signal radiates from the waveguide to a tag that is attached to an object in the stack. The tag may process the first RF signal and transmit a second RF signal to the tag reader via the waveguide.

These and other objects, advantages and features will become readily apparent in view of the following detailed description of the invention.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A shows a plan view of an example RFID tag according to an embodiment of the present invention.

FIG. 1B is a block diagram of an example RFID tag interrogation system according to an embodiment of the present invention.

FIG. 2A illustrates an interrogation system according to an embodiment of the present invention.

FIG. 2B illustrates a stack placed upon a pallet according to an embodiment of the present invention.

FIG. 3A illustrates a rectangular waveguide according to an embodiment of the present invention.

FIG. 3B illustrates a circular waveguide according to an embodiment of the present invention.

FIG. 4A illustrates the rectangular waveguide of FIG. 3A having more than one opening according to an embodiment of the present invention.

FIG. 4B illustrates the circular waveguide of FIG. 3B having more than one opening according to an embodiment of the present invention.

FIG. 5A shows an example transverse electric (TE) mode surface waveguide according to an embodiment of the present invention.

FIG. 5B is a side view of example TE mode surface waveguide according to another embodiment of the present invention.

FIG. 5C is a side view of example TE mode surface waveguide according to yet another embodiment of the present invention.

FIGS. 5D and 5E are plan views of the TE mode surface waveguide as shown in FIG. 5C including a transition region according to embodiments of the present invention.

FIG. 5F shows an example transverse magnetic (TM) mode surface waveguide according to an embodiment of the present invention.

FIG. 6A shows an example parallel plate waveguide (PPW) according to an embodiment of the present invention.

FIG. 6B is a side view of example parallel plate waveguide according to another embodiment of the present invention.

FIG. 6C is an example asymmetric stepped height transition according to an embodiment of the present invention.

FIG. 6D is a graphical representation of S-parameters associated with the asymmetric stepped height transition of FIG. 6C according to an embodiment of the present invention.

FIG. 6E shows views of a parallel plate waveguide having a V-shaped coupling aperture according to an embodiment of the present invention.

FIG. 6F illustrates a parallel plate waveguide having transition coupling slots and tag coupling slots according to an embodiment of the present invention.

FIG. 6G illustrates several types of resonant coupling slots according to embodiments of the present invention.

FIG. 7A shows a first example test configuration for the TE mode surface waveguide of FIGS. 5A-5E, according to an embodiment of the present invention.

FIG. 7B shows a modified stacking pattern for the first example test configuration of FIG. 7A according to an embodiment of the present invention.

FIG. 8 shows a second example test configuration for the TE mode surface waveguide of FIGS. 5A-5E, according to an embodiment of the present invention.

FIG. 9 shows an example test configuration for the parallel plate waveguide of FIGS. 6A-6G, according to an embodiment of the present invention.

FIG. 10 shows an example pallet-stacking pattern according to an embodiment of the present invention.

FIG. 11A provides a graphical comparison between measured data and modeled data for the real part of the dielectric constant of Pantene Pro-V® shampoo according to embodiments of the present invention.

FIG. 11B provides a graphical comparison between measured data and modeled data for the imaginary part of the dielectric constant of Pantene Pro-V® shampoo according to embodiments of the present invention.

FIG. 12 illustrates the placement of 750 ml Pantene Pro-V® shampoo bottles in cases that were used for testing the configurations of FIGS. 7-10 according to an embodiment of the present invention.

FIG. 13 shows an example hard electromagnetic surface waveguide according to an embodiment of the present invention.

FIG. 14A shows a single-layer FSS having interdigital capacitors according to an embodiment of the present invention.

FIG. 14B shows a dual-layer FSS having overlay capacitors according to another embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### 1.0 INTRODUCTION

The present invention relates to radio frequency identification (RFID) technology. More specifically, embodiments of the invention include methods, systems, and apparatuses for reading RFID tags in a stack of objects.

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications. For example, in the following description, for illustrative purposes, embodiments may be described in terms of a particular waveguide type (e.g., transverse electric (TE) mode, transverse magnetic (TM) mode). However, it would be apparent to persons skilled in the relevant art(s) that alternative types of waveguides may be used in embodiments of the present invention, including but not limited to transverse electromagnetic (TEM) mode surface waveguides (e.g., waveguides that have no electric or magnetic field in the direction of propagation).

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

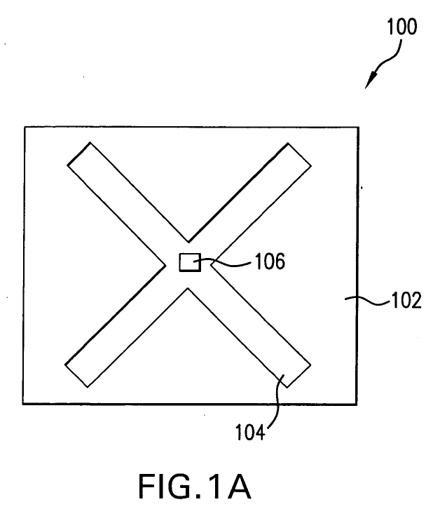

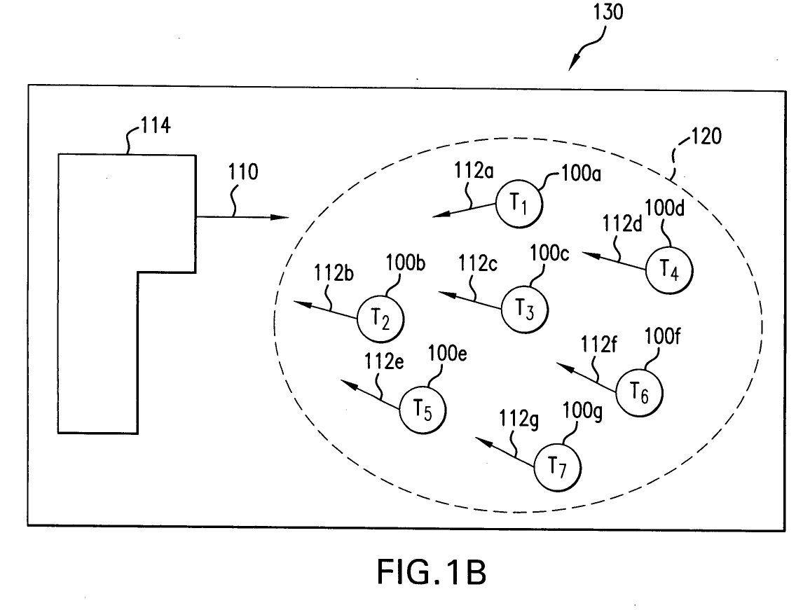

The present invention is applicable to any type of RFID tag. FIG. 1A shows a plan view of an example RFID tag 100 according to an embodiment of the present invention. Tag 100 includes a substrate 102, an antenna 104, and an integrated circuit (IC) 106. Antenna 104 is formed on a surface of substrate 102. IC 106 includes one or more integrated circuit chips/dies and/or other electronic circuitry. IC 106 is attached to substrate 102, and is coupled to antenna 104. IC 106 may be attached to substrate 102 in a recessed and/or non-recessed location. IC 106 controls operation of tag 100 and transmits signals to, and receives signals from, RFID readers using antenna 104. The present invention is applicable to tag 100, and to other types of tags, including surface acoustic wave (SAW) tags.

FIG. 1B is a block diagram of an example RFID tag interrogation system 130 according to an embodiment of the present invention. Tag interrogation system 130 includes a RFID reader 114 and an example population 120 of RFID tags 100. As shown in FIG. 1B, the population 120 of tags 100 includes a first tag 100a, a second tag 100b, a third tag 100c, a fourth tag 100d, a fifth tag 100e, a sixth tag 100f, and a seventh tag 100g. These seven tags 100 are shown in the population 120 for exemplary purposes. According to embodiments of the present invention, a population 120 of tags 100 may include any number of one or more tags 100. In some embodiments, very large numbers of tags 100 may be included in a population 120 of tags 100, including hundreds, thousands, or even more tags 100.

As shown in FIG. 1B, one or more interrogation signals 110 are transmitted from RFID reader 114 to the population 120 of tags 100. One or more response signals 112 are transmitted from RFID tags 100 to RFID reader 114. For example, as shown in FIG. 1B, first tag 100a transmits a first response signal 112a, second tag 100b transmits a second response signal 112b, third tag 100c transmits a third response signal 112c, fourth tag 100d transmits a fourth response signal 112d, fifth tag 100e transmits a fifth response signal 112e, sixth tag 100f transmits a sixth response signal 112f, and seventh tag 100g transmits a seventh response signal 112g.

According to the present invention, signals 110 and 112 are exchanged between RFID reader 114 and tags 100 according to one or more communication protocols. RFID reader 114 can communicate with tags 100 according to any communications protocol/algorithm, as required by the particular application. For example, RFID reader 114 can communicate with tags 100 according to a binary algorithm, a tree traversal algorithm, or a slotted aloha algorithm. RFID reader 114 can communicate with tags 100 according to a standard protocol, such as Class 0, Class 1, EPC Gen2, and any other known or future developed RFID communications protocol/algorithm.

Signals 110 and 112 are wireless signals, such as radio frequency (RF) transmissions. Upon receiving a signal 110, a tag 100 may produce a responding signal 112 by alternately reflecting and absorbing portions of signal 110 according to a time-based pattern. The time-based pattern is determined according to information that is designated for transmission to RFID reader 114. This technique of alternately absorbing and reflecting signal 110 is referred to herein as backscatter modulation. Persons skilled in the art will recognize that tags 100 may employ any of a variety of approaches to perform backscatter modulation. For example, tags 100 may vary the impedance characteristics of onboard receive circuitry, such as one or more antennas and/or other connected electronic components.

Each tag 100 has an identification number. In certain embodiments, each of tags 100 has a unique identification number. However, in other embodiments, multiple tags 100 may share the same identification number, or a portion thereof. During the aforementioned communications with tags 100, RFID reader 114 receives identification numbers from tags 100 in response signals 112. Depending on the protocol employed for such communications, the retrieval of identification numbers from tags 100 may involve the exchange of signals over multiple iterations. In other words, the receipt of a single identification number may require RFID reader 114 to transmit multiple signals 110. In a corresponding manner, tags 100 will respond with respective signals 112 upon the receipt of each signal 110, if a response is appropriate.

Alternatively or in addition to identification numbers, RFID reader 114 may send other information to tags 100. For example, RFID reader 114 may store a unit of information in one or more of tags 100 to be retrieved at a later time. Depending upon the design of tags 100, this could be volatile or non-volatile information storage and retrieval.

RFID reader 114 may also obtain information generated by sensors that are included in tags 100. When provided to RFID reader 114, this sensor information may include information regarding the operational environments of tags 100, for example.

A variety of sensors may be integrated with tags 100. Exemplary sensors include: gas sensors that detect the presence of chemicals associated with drugs or precursor chemicals of explosives such as methane, temperature sensors that generate information indicating ambient temperature, accelerometers that generate information indicating tag movement and vibration, optical sensors that detect the presence (or absence) of light, pressure sensors that detect various types of tag-encountered mechanical pressures, tamper sensors that detect efforts to destroy tags and/or remove tags from affixed items, electromagnetic field sensors, radiation sensors, and biochemical sensors. However, this list is not exclusive. In fact, tags 100 may include other types of sensors, as would be apparent to persons skilled in the relevant arts.

Each of tags 100 is implemented so that it may be affixed to a variety of items. For example a tag 100 may be affixed to airline baggage, retail inventory, warehouse inventory, automobiles, and other objects. In some circumstances, the objects to which tags 100 are affixed may be stacked. In conventional RFID interrogation systems, stacking the objects hinders communication between RFID reader 114 and tags 100 that are affixed to the stacked objects. For example, tags 100 toward the center of the stack may not receive a signal 110 transmitted by RFID reader 114 because objects surrounding those tags 100 block or absorb the signal 110. In another example, the surrounding objects may block or absorb signals 112 transmitted from those tags 100, hindering detection of signals 112 by RFID reader 114. The present invention attempts to resolve these problems by facilitating communication between RFID reader 114 and tags 100 that are stacked or blocked.

### 2.0 EXAMPLE WAVEGUIDE EMBODIMENTS

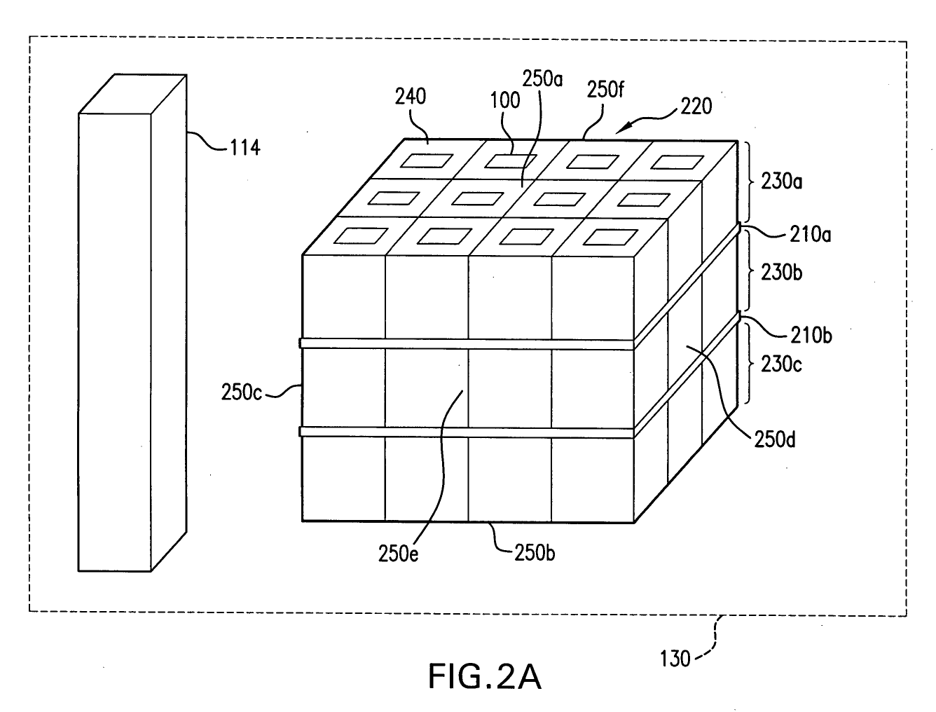

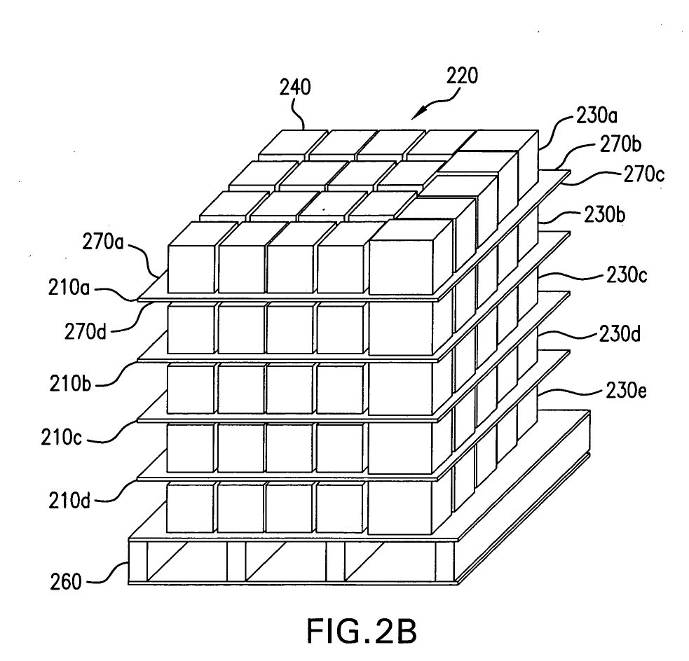

FIG. 2A illustrates an interrogation system 130 according to an embodiment of the present invention. In FIG. 2A, interrogation system 130 includes waveguides 210a and 210b that are used to facilitate communication between RFID reader 114 and tags 100 that are coupled to objects 240 in a stack 220. In the embodiment of FIG. 2A, stack 220 includes three layers 230a-c of objects 240. A waveguide 210 is provided between adjacent layers 230 to carry signals between RFID reader 114 and tags 100 that are coupled to objects 240. Waveguide 210a is provided between layers 230a and 230b. Waveguide 210b is provided between layers 230b and 230c. Interrogation system 130 can include any number of waveguides 210 and/or layers 230 of objects 240. Moreover, layers 230 can include any number of objects 240, and layers 230 need not necessarily include the same number of objects 240.

In FIG. 2A, stack 220 has six surfaces 250a-f, though the scope of the invention is not limited in this respect. For example, stack 220 may be a cylinder, a pyramid, a cone, or any other shape. In another example, stack 220 may be a pile of objects 240 having a random or semi-random distribution. Stack 220 can have any number of layers 230, including one. For example, in a one layer embodiment, a waveguide 210 may be present on a shelf, and objects 240 may be positioned on layer 230 on the shelf. Such a configuration may aid in reading objects positioned behind other objects on a shelf.

Referring to FIG. 2A, objects 240 in the middle of stack 220 may be difficult to read due to the radio frequency (RF) signal loss passing through objects 240 in stack 220. Waveguides 210a and 210b can guide radio waves to locations within stack 220, so that tags 100 affixed to objects 240 in the interior of stack 220 may detect the radio waves.

Radio waves decay exponentially with distance as the radio waves travel into a stack of absorptive products, such as shampoo, for example. Many commercial products impose such a high RF loss that buried tags (i.e., tags that are not exposed to a surface 250 of stack 220) cannot be read. Waveguides 210a-b bridge the performance gap between tags 100 and RFID reader 114, allowing tags 100 within stack 220 to communicate with RFID reader 114.

Any of a variety of waveguides 210 may be used to facilitate communication between tags 100 and RFID reader 114. Waveguide 210 may be flexible or rigid and may be composed of any suitable material or combination of materials. According to an embodiment, waveguide 210 is a rigid planar RF waveguide configured to guide 900 MHz radio waves to locations within a pallet stack. Waveguide 210 may be used with conventional reader systems, such as a conventional MATRICS portal reader system. Persons skilled in the art will recognize that embodiments of the present invention are adaptable to frequencies other than those described herein.

FIG. 2B illustrates a stack 220 placed upon a pallet 260 according to an embodiment of the present invention. In FIG. 2B, waveguides 210a-d replace slipsheets, which are traditionally placed between horizontal layers of cases in a pallet stack.

In FIG. 2B, each layer 230 of objects 240 (e.g., cases) is separated from an adjacent layer 230 by a waveguide 210. However, multiple layers 230 of objects 240 can be placed between waveguides 210. As shown in FIG. 2B, objects 240 of a layer 230 need not necessarily be the same size.

Referring to FIG. 2B, each of waveguides 210a-d includes edge portions 270a-d, which extend beyond the perimeter of layers 230a-e. Edge portions 270a-d facilitate communication between RFID reader 114 and tags that are affixed to objects 240 in layers 230a-e. Any one or more of waveguides 210a-d can include an edge portion 270a, 270b, 270c, and/or 270d. Waveguides 210a-d need not necessarily include edge portions 702a-d.

In the embodiment of FIG. 2B, waveguides 210a-d are depicted as electromagnetic hard surfaces, though the scope of the invention is not limited in this respect. Waveguides 210a-d need not necessarily be rigid and may be flexible. For example, stack 220 may include a supporting layer beneath each waveguide 210a-d. The supporting layers may provide structural support for respective waveguides 210a-d.

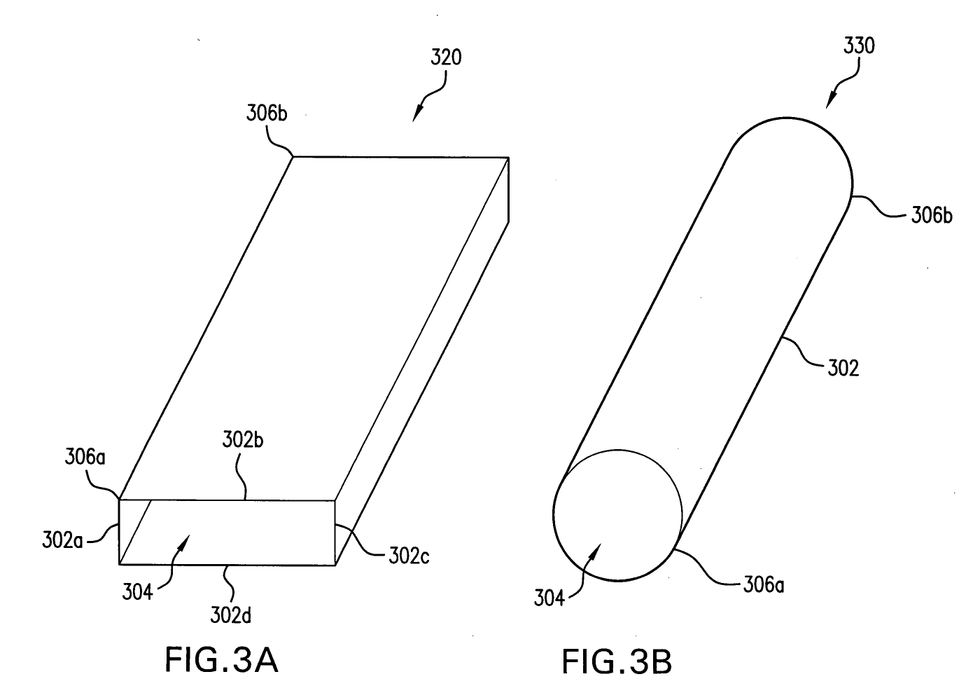

A waveguide may be described as a hollow “tube” having wall(s) that surround a dielectric, such as air. The wall(s) of the waveguide provides distributed inductance, and the space between the wall(s) provides distributed capacitance. FIGS. 3A and 3B illustrate some example waveguides according to embodiments of the present invention.

FIG. 3A illustrates a rectangular waveguide 320 according to an embodiment of the present invention. In FIG. 3A, waveguide 320 has four walls 302a-d that surround a hollow portion 304. Hollow portion 304 extends from a first end 306a of waveguide 320 to a second end 306b of waveguide 320. A signal can travel along waveguide 320 from first end 302a to second end 302b or vice versa.

FIG. 3B illustrates a circular waveguide 330 according to an embodiment of the present invention. In FIG. 3B, waveguide 330 has a single wall 302 that surrounds a hollow portion 304. Hollow portion 304 extends from a first end 306a of waveguide 330 to a second end 306b of waveguide 330.

A waveguide need not necessarily be rectangular or circular as described above with reference to FIGS. 3A and 3B, respectively. For example, a waveguide can be elliptical or any other shape. A waveguide can have any suitable number of sides.

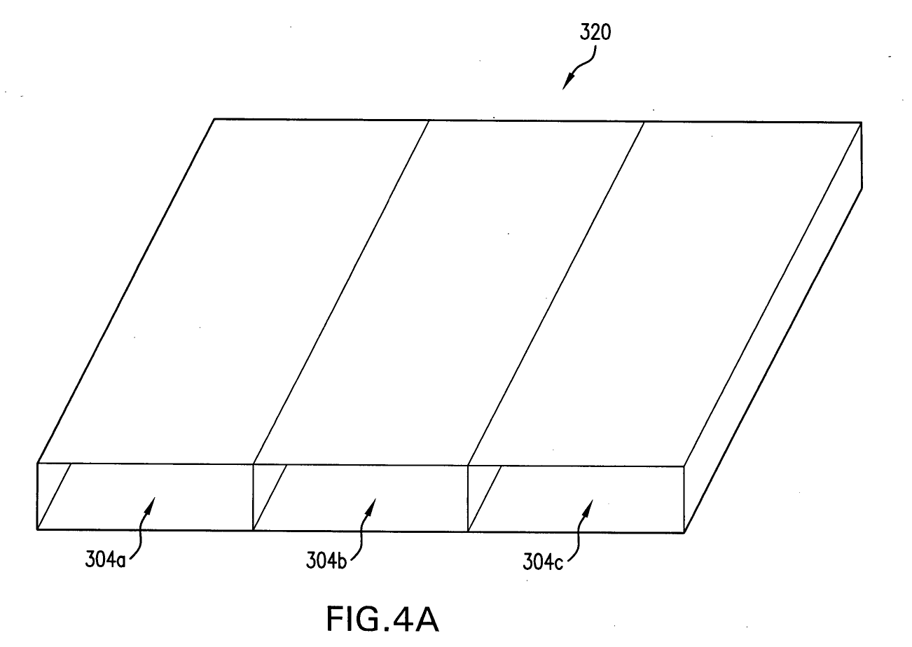

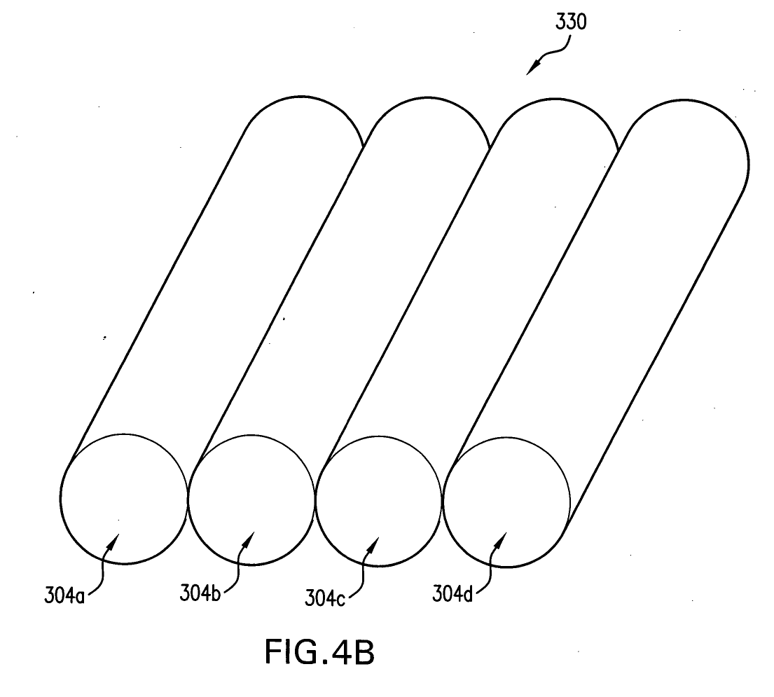

FIGS. 4A and 4B illustrate that a waveguide can have more than one hollow portion 304. For example, FIG. 4A shows waveguide 320 of FIG. 3A having an array of three openings 304a-c according to an embodiment of the present invention. Waveguide 320 can include any number of openings 304, and openings 304 need not necessarily be arranged in an array. In FIG. 4A, adjacent openings 304 share a common wall. However, the scope of the present invention is not limited in this respect. Walls surrounding adjacent openings 304 may or may not be in contact with each other.

FIG. 4B shows waveguide 330 of FIG. 3B having four openings 304a-d according to an embodiment of the present invention. Waveguide 330 can include any number of openings 304, and openings 304 may be arranged in any of a variety of configurations.

2.1 TE Mode Surface Waveguide Embodiment

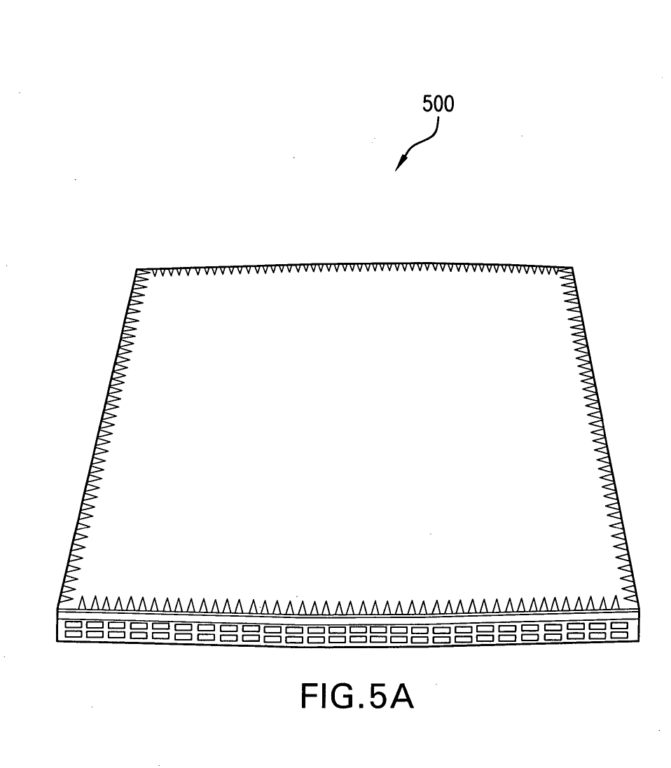

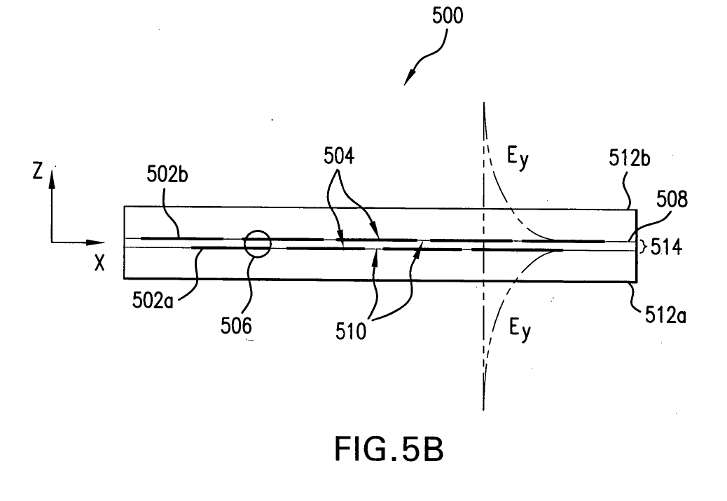

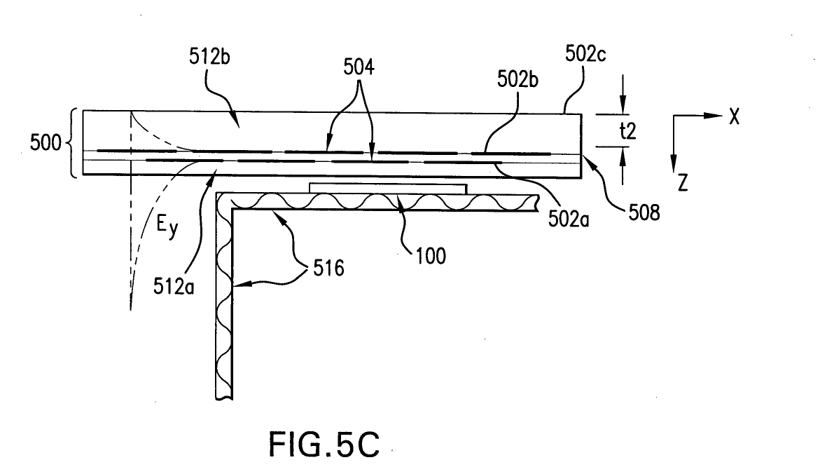

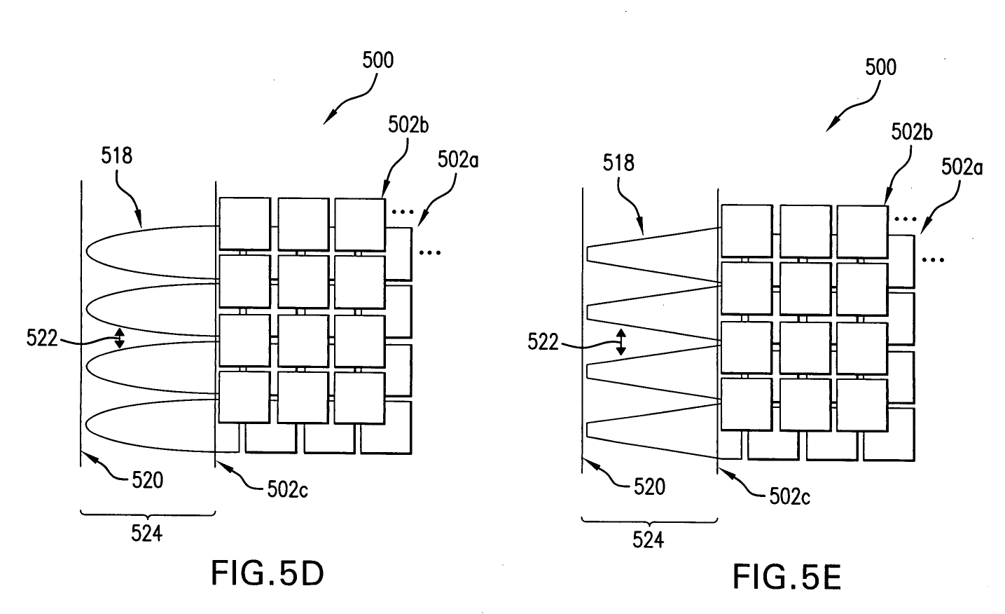

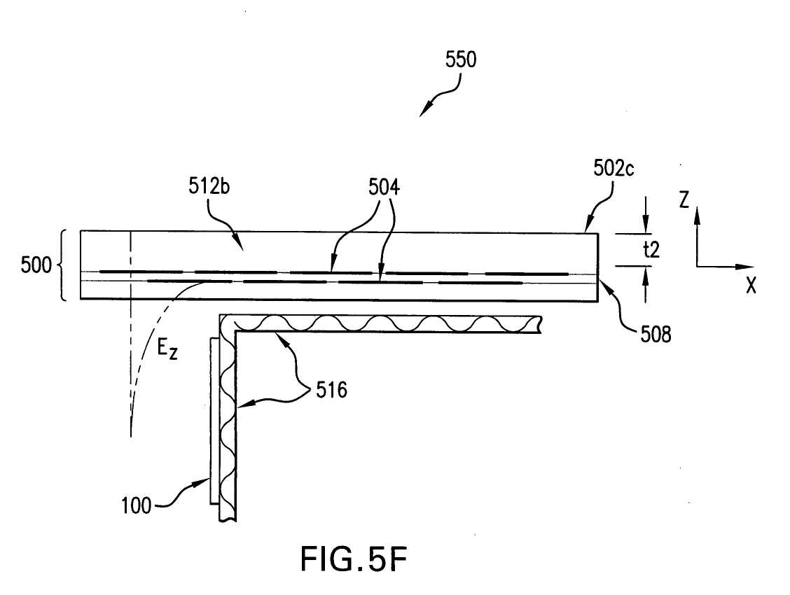

FIG. 5A shows an example transverse electric (TE) mode surface waveguide 500 according to an embodiment of the present invention. A signal can be transmitted by RFID reader 114 or a tag 100 along TE mode surface waveguide 500 to facilitate or enable communication between RFID reader 114 and tag 100. A signal propagating along TE mode surface waveguide 500 has an associated magnetic field and an associated electric field. The electric field is perpendicular (transverse) to the direction of propagation of the signal, and the magnetic field is in the direction of propagation of the signal.

FIG. 5B is a side view of example TE mode surface waveguide 500 according to another embodiment of the present invention. In FIG. 5B, TE mode surface waveguide 500 includes a capacitive layer 514 having metallic layers 502a-b and a dielectric layer 508 provided between metallic layers 502a-b. Each metallic layer 502 includes Cohn squares 504 that are separated by gaps 510. For example, Cohn squares 504 may be printed on opposing sides of a thin dielectric film, such as Mylar. According to an embodiment, capacitive layer 514 may be implemented as an array of co-planar inter-digital capacitors.

Referring to FIG. 5B, power propagates in the x direction. Cohn squares 504 in metallic layers 502a-b overlap in the z-direction to provide overlapping regions 506. Overlapping regions 506 provide an effective sheet capacitance that can guide a TE mode “skin wave”. The highest energy density is found in a thin layer or skin associated with metallic layers 502a-b. Transverse, or y-directed, electric fields decay exponentially both above and below capacitive layer 514, as illustrated in FIG. 5B. Protective dielectric layers 512a-b, such as cardboard, can be bonded to each side of capacitive layer 514 to protect metallic layers 502a-b from damage and/or to help separate the high field strength regions of the slots from the lossy dielectric of a product being transported in close proximity to TE mode surface waveguide 500.

TE mode surface waveguide 500 is one of the easiest potential waveguide solutions to fabricate. TE mode surface waveguide 500 may have a relatively high attenuation per unit length, as compared to other potential waveguide solutions, due to the exponentially decreasing tail of the electric field in the region above TE mode surface waveguide 500. If TE mode surface waveguide 500 is provided between cases of shampoo bottles, for example, the tail of the electric field may sweep across the bottom of the shampoo bottles, and be either reflected or significantly absorbed.

FIG. 5C is a side view of example TE mode surface waveguide 500 according to yet another embodiment of the present invention. In the embodiment of FIG. 5C, TE mode surface waveguide 500 includes metallization layer 502c coupled to protective dielectric layer 512b. For example, metallization layer 502c may be a metal foil. According to an embodiment, metallization layer 502c serves as a ground plane to ensure that fields of the guided TE mode do not become absorbed by a lossy dielectric in relatively close proximity to TE mode surface waveguide 500. TE mode surface waveguide 500 including the ground plane may be referred to as a grounded-capacitive frequency-selective structure (FSS).

FIG. 5C shows a tag 100 affixed to a cardboard case 516, which may store bottles of shampoo, for example. As shown in FIG. 5C, the surface wave is characterized by an exponentially decreasing electric field extending downward into the top of cardboard case 516. The closest shampoo in cardboard case 516 to TE mode surface waveguide 500 may be multiple inches (e.g., 2.5″) from TE mode surface waveguide 500. Other cardboard cases of shampoo may be placed on top of TE mode surface waveguide 500. The closest shampoo in the other cardboard cases to TE mode surface waveguide 500 may be much closer (e.g., 1 mm) to TE mode surface waveguide 500. A good place for tag 100 is the top surface of cardboard case 516, as shown in FIG. 5C, where the electric field strength is the greatest. However, tag detuning may be an issue for this location.

One of the engineering challenges in any surface waveguide solution is the design of a transition region at the perimeter of the waveguide. This modal transition captures a portion of the plane wave power incident upon the pallet stack and converts this power into the intended surface wave mode.

FIGS. 5D and 5E are plan views of TE mode surface waveguide 500 as shown in FIG. 5C including a transition region 524 according to embodiments of the present invention. In FIGS. 5D and 5E, metallic layer 502a includes tapered fingers 518 arranged along a perimeter 520 of TE mode surface waveguide 500. Transition region 524 extends from a perimeter of metallic layer 502c to a perimeter of TE mode surface waveguide 500. Transition region 524 includes tapered slots 522 between tapered fingers 518. For a TE mode, tapered slots 522 may facilitate the capture of power from a horizontally polarized incident electric field, for example.

TE mode surface waveguide 500 may have a field decay constant in the transverse (z) direction of between 2 dB and 3 dB per inch, for example.

2.2 Parallel Plate Waveguide Embodiment

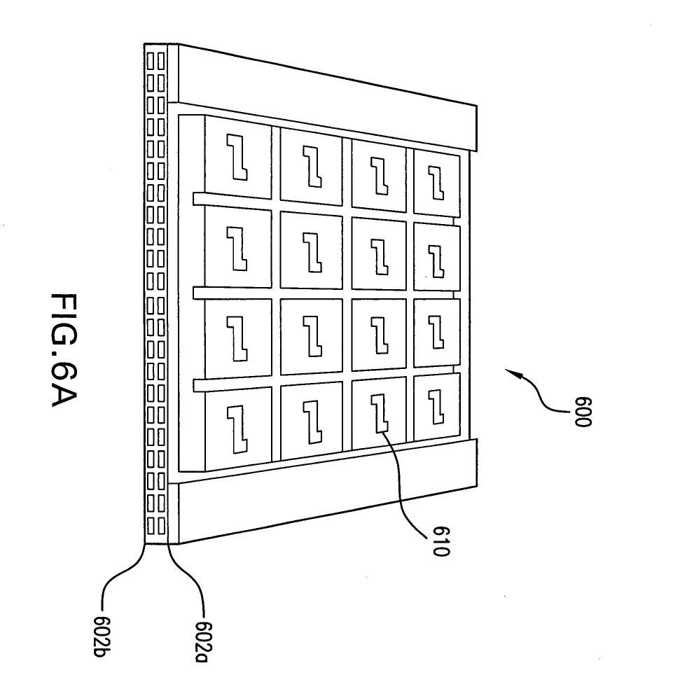

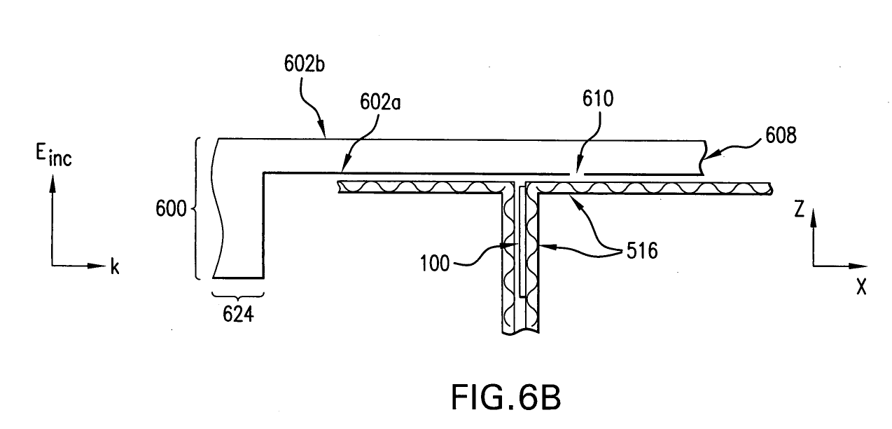

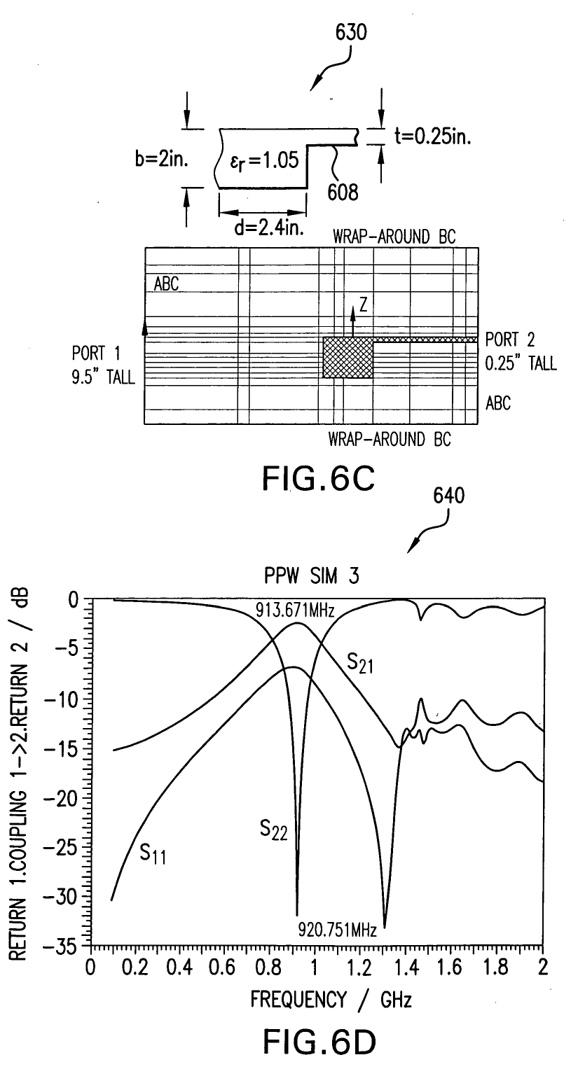

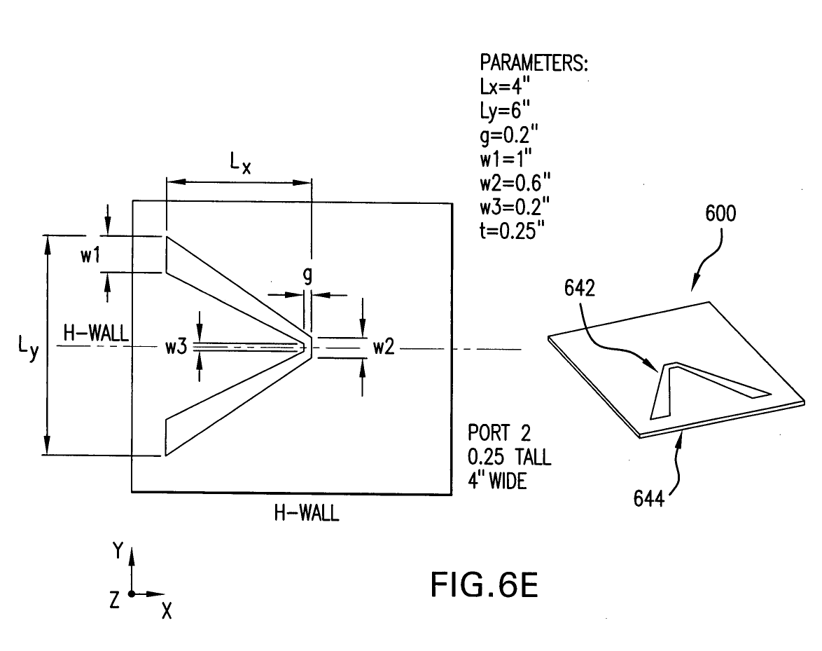

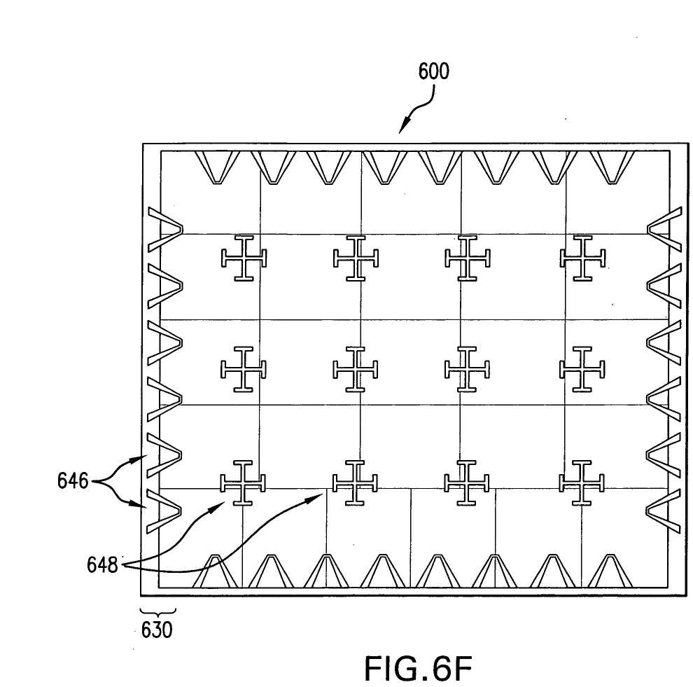

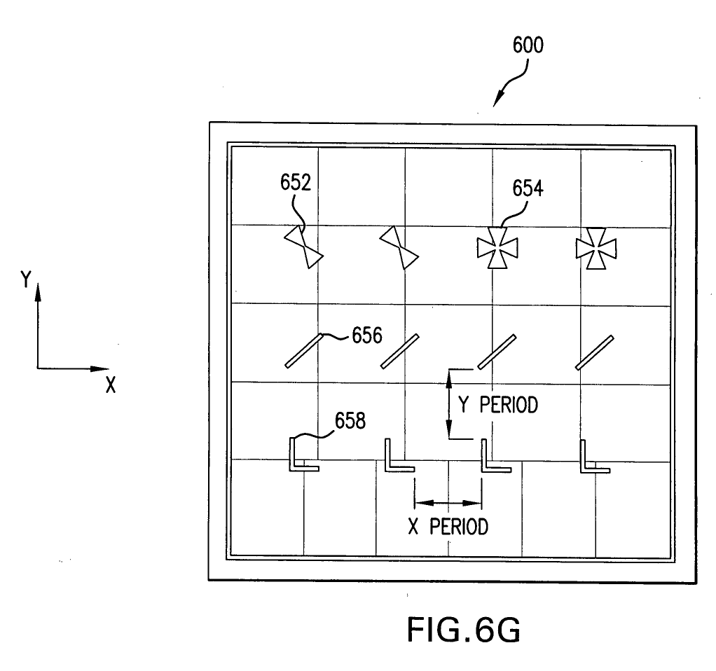

FIG. 6A shows an example parallel plate waveguide (PPW) 600 according to an embodiment of the present invention. Parallel plate waveguide 600 includes two metallic layers 602a-b and resonant coupling slots 610. Metallic layers 602a-b may be coupled in any of a variety of ways. The frequency response of parallel plate waveguide 600 may be manipulated by changing the thickness of metallic layers 602a-b and/or changing the size of resonant coupling slots 610.

FIG. 6B is a side view of example parallel plate waveguide 600 according to another embodiment of the present invention. Parallel plate waveguide 600 includes ground planes 602a-b and dielectric 608, which is provided between ground planes 602a-b. Ground planes 602a-b are substantially parallel in the embodiment of FIG. 6B. Ground plane 602a has a slot 610 through which RF power radiates. For example, RF power may radiate through slot 610 into a pallet stack.

An incident vertically polarized electric field (E_{inc}) may excite parallel plate waveguide 600 by impressing a voltage between ground planes 602a-b. The relatively tall transition region 624 at the edge of parallel plate waveguide 600 is an impedance matching device. According to an embodiment, parallel plate waveguide 600 (1) is configured to have a transition region 624 at the perimeter of parallel plate waveguide 600 which allows efficient capture of RF energy at 900 MHz, (2) is configured to have resonant coupling slots (e.g., slot 610) with the proper coupling level to permit roughly uniform excitation of RF signal strength within the pallet stack, and (3) is configured to have the resonant coupling slots such that they are each tuned on-frequency.

In an embodiment, a reactive, or tuned, transition is present at the perimeter of parallel plate waveguide 600 because without it, the coupling level into parallel plate waveguide 600 having a height of 0.25″ is approximately −15 dB, which is equal to the optical cross section of 0.25″, divided by the vertical period (i.e., case height plus the thickness of parallel plate waveguide 600) of 9.5″.

FIG. 6C is an example asymmetric stepped height transition 630 according to an embodiment of the present invention. In FIG. 6C, the thickness of dielectric 608 steps from 2 inches to 0.25 inches

FIG. 6D is a graphical representation 640 of S-parameters associated with asymmetric stepped height transition 630 according to an embodiment of the present invention. As shown in FIG. 6D, the coupling (or RF cross-section) of asymmetric stepped height transition 630 peaks above −3 dB. Asymmetric stepped height transition 630 is effective at capturing more than 50% of the incident power over the 902-928 MHz RFID band. Asymmetric stepped height transition 630 may be too long at 2.4″ to be used in some practical parallel plate waveguide 600 designs, but it shows the remarkable improvement in S₂₁ that is available with a properly designed transition.

The length of transition 630 may be shortened in any of a variety of ways. According to an embodiment, an aperture capacitor that is fabricated as interdigital fingers is used to shorten the transition length. In another embodiment, a linear array of V-shaped coupling apertures cut or etched into a side of parallel plate waveguide 600 is used as a tuned transition.

FIG. 6E shows a parallel plate waveguide 600 having a V-shaped coupling aperture 642 according to an embodiment of the present invention. In the embodiment of FIG. 6E, V-shaped coupling aperture 642 is etched into a shorting wall 644 of height t. In FIG. 6E, parallel plate waveguide 600 is not tuned to the RFID band. Because V-shaped coupling aperture 642 is symmetric about it center, and the plane wave is incident from the normal (0°) direction, it is sufficient to simulate half of V-shaped coupling aperture 642 using magnetic wall boundary conditions to predict the full-wave performance. The configuration shown in FIG. 6E is not optimized, but the coupling level, S₂₁, peaks at approximately −6 dB. In other words, approximately 25% of the incident power is captured. At least eight variables are used to uniquely define a transition at V-shaped coupling aperture 642.

FIG. 6F illustrates a parallel plate waveguide 600 having a plurality of transition coupling slots 646 and tag coupling slots 648 according to an embodiment of the present invention. Transition coupling slots 646 couple power into parallel plate waveguide 600 at transition region 630, which extends along the perimeter of parallel plate waveguide 600 in FIG. 6F. Tag coupling slots 648 allow the power to radiate from parallel plate waveguide 600 to tags 100 (not shown). In FIG. 6F, transition coupling slots 646 and tag coupling slots 648 are shown as V-shaped coupling apertures and crosses, respectively, for illustrative purposes. However, the example shapes provided in FIG. 6F are not intended to limit the scope of the present invention. Transition coupling slots 646 and tag coupling slots 648 may be any of a variety of shapes.

FIG. 6G illustrates several types of resonant coupling slots according to embodiments of the present invention. In FIG. 6G, parallel plate waveguide 600 includes slots shaped as bowties 652, crossed bowties 654, slanted slots 656, and L-slots 658, to provide some examples. The list of slot shapes provided herein is not intended to be an exhaustive list. The resonant coupling slots may be any shape. Persons skilled in the art will recognize that parallel plate waveguide 600 can include any of a variety of combinations of transition coupling slots and tag coupling slots, for example.

In FIG. 6G, the distance between slots in the x direction is referred to as the “x period”, and the distance between slots in the y direction is referred to as the “y direction”. The x period and the y period may be different for different applications. For example, the x period and the y period may be provided as variables to be determined through testing and/or computer optimization, as would be understood by persons skilled in the relevant art(s).

TE and TM mode surface waveguides 500 and 550, respectively, as described above with reference to FIGS. 5A-5F, have fewer design variables, as compared to parallel plate waveguide 600. On the other hand, parallel plate waveguide 600 requires fewer layers of metal than TE and TM mode surface waveguides 500 and 550. Parallel plate waveguide 600 may be less expensive to fabricate in large volume production than TE and TM mode surface waveguides 500 and 550.

2.3 TM Mode Surface Waveguide Embodiment

FIG. 5F shows an example transverse magnetic (TM) mode surface waveguide 550 according to an embodiment of the present invention. In FIG. 5F, TM mode surface waveguide 550 is similar to TE mode surface waveguide 500 shown in FIG. 5C, except that fields associated with a signal that propagates along TM mode surface waveguide 550 are aligned differently than those associated with a signal that propagates along TE mode surface waveguide 500. A signal propagating along TM mode surface waveguide 550 has an associated electric field that is in the direction of propagation of the signal and an associated magnetic field that is perpendicular (transverse) to the direction of propagation of the signal. In FIG. 5F, tag 100 is affixed to the side of cardboard case 516 (perpendicular to waveguide 550), rather than the top of cardboard case 516 (parallel to waveguide 500) as shown in the TE mode surface waveguide embodiment of FIG. 5C. Positioning tag 100 on the side of cardboard case 516 allows tag 100 to couple into the z-directed electric field of the TM mode.

The same grounded-capacitive FSS that may guide a TE mode may also guide a TM mode. However, the field decay rate in the transverse direction for the TM mode is extremely weak. This means that the TM mode will be poorly attached to TM mode surface waveguide 550. For example, more energy may be guided in an air region about TM mode surface waveguide 550 than within TM mode surface waveguide 550. In FIG. 5F, much of the guided power may quickly be consumed by shampoo stored in case 516, because the decay rate for the electric field is on the order of approximately 0.05 dB per inch at 900 MHz.

To force the TM mode to be more tightly bound to the surface of TM mode surface waveguide 550 (or to raise the TM mode surface reactance) one can introduce vertical conductors or vias between metallization layer 502c and Cohn squares 504. Introducing vertical conductors or vias may significantly increase manufacturing cost, for example, for both a prototype and potential large volume production.

2.4 Hard Electromagnetic Surface Embodiment

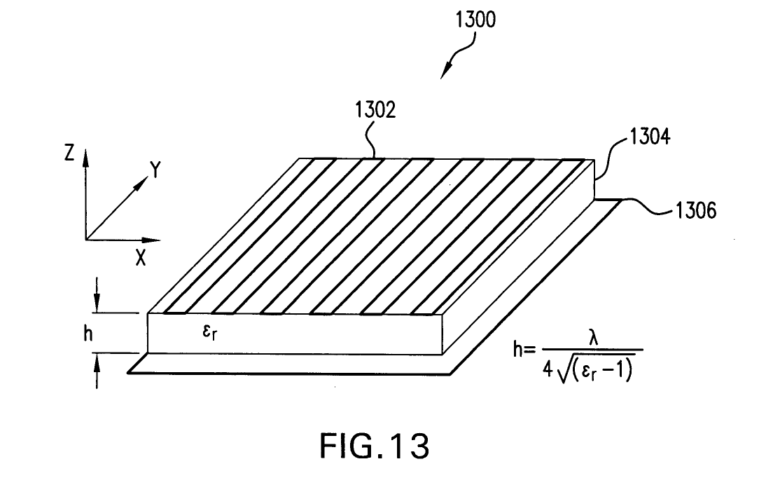

FIG. 13 shows an example hard electromagnetic surface waveguide 1300 according to an embodiment of the present invention. Hard electromagnetic surface waveguide 1300 includes longitudinal strips 1302, a ground plane 1306, and a dielectric layer 1304 between longitudinal strips 1302 and ground plane 1306.

Hard surfaces are able to guide a TEM mode along the surface with a Poynting vector aligned with the longitudinal direction of longitudinal strips 1302. The TEM wave sees a low impedance along longitudinal strips 1302 and a high impedance for directions transverse to longitudinal strips 1302. Longitudinal strips 1302 provide an anisotropic reactive surface.

Referring to FIG. 13, recent research suggests that the TEM mode decays with distance away from the surface at frequencies above the mid-band frequency of operation. Experimental evidence suggests that vertically polarized waves are strongly attached to anisotropic reactive surfaces, such as that provided by longitudinal strips 1302, much more so than for a simple ground plane.

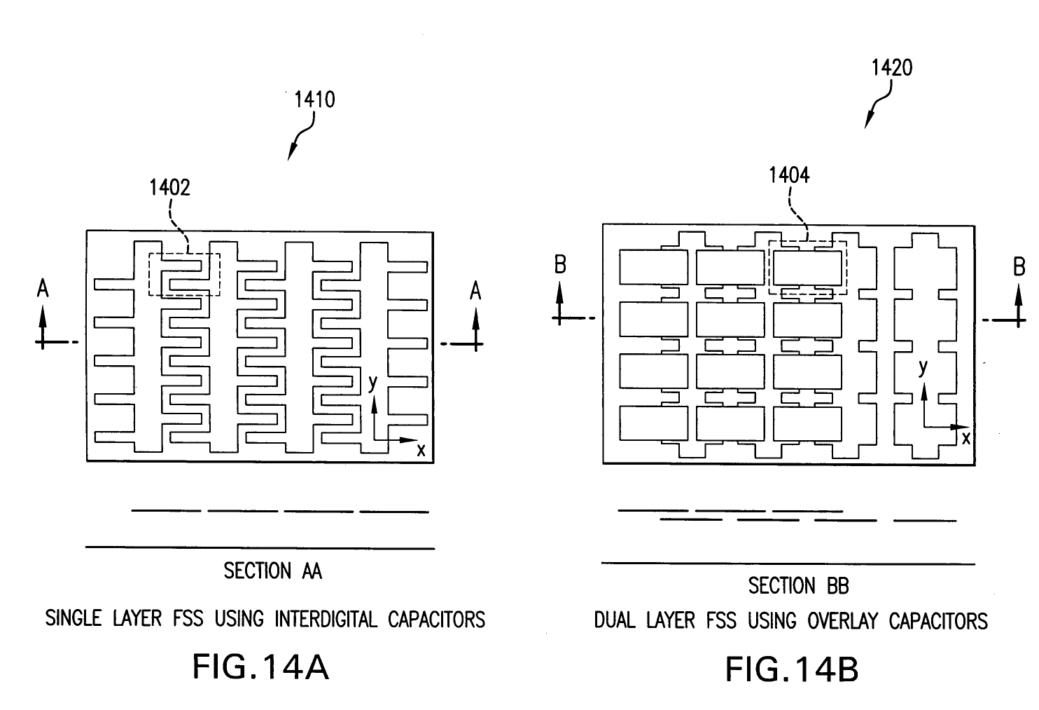

Dielectric layer 1304 of hard electromagnetic surface waveguide 1300 may be too thick and/or heavy for some 900 MHz applications. However, hard surfaces may be manufactured with lower profile and/or less mass by loading longitudinal strips 1302 with capacitance in the transverse direction. Increasing the capacitance of longitudinal strips 1302 may be achieved in any of a variety of ways. FIG. 14A shows a single-layer FSS (e.g., hard electromagnetic surface waveguide 1300) having interdigital capacitors 1402 according to an embodiment of the present invention. FIG. 14B shows a dual-layer FSS having overlay capacitors 1404 according to another embodiment of the present invention. In FIG. 14B, overlay capacitors 1404 may be formed using overlapping metallic patches, such as Cohn squares.

### 3.0 TESTING SOME EXAMPLE WAVEGUIDE EMBODIMENTS

The example waveguides described above in sections 2.1, 2.2, and 2.3 are provided for illustrative purposes only and are not intended to limit the scope of the invention. Following is a list of example waveguide design steps that were implemented to determine the waveguides used.

Task 1: Identification of Potential Solutions—Potential solutions that were considered include electromagnetic surface waveguides capable of guiding either TE or TM modes, as well as parallel-plate waveguide modes.

Task 2: Risk Matrix—A cost and technical risk assessment was created for the potential waveguide solutions.

Task 3: Electromagnetic Simulations—The proposed solutions were simulated with the computational electromagnetic code Microstripes TM to identify propagation decay rates in a lossy environment, which was intended to simulate the cases of shampoo. The simulations included a Debye model for the shampoo.

Task 4: Prototype Fabrication—Customer components were fabricated, and five units of a waveguide prototype were thereafter assembled.

Task 5: RF Testing—The result of reading into a pallet stack of shampoo when using the prototype waveguide units was quantified.

Task 6: Final Report.

The following are example design parameters in example embodiments, provided for illustrative purposes:

1. The footprint of the waveguide is 40″×48″.

2. The thickness of the waveguide is 14″ maximum except at the edges.

3. The waveguide operates from at least 860 MHz to 960 MHz.

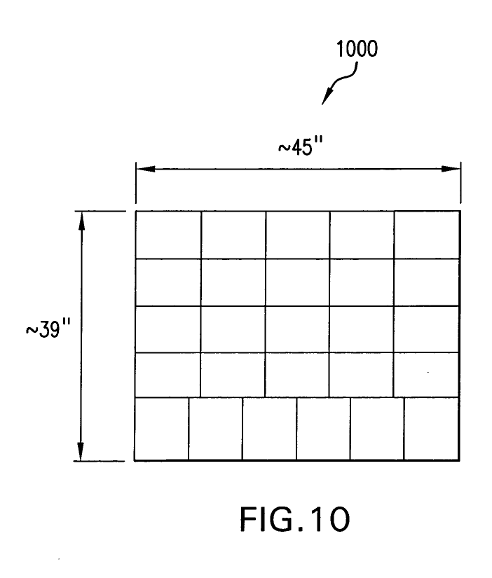

4. The waveguide is compatible with the example pallet-stacking pattern 1000 of FIG. 10.

In an example environment, the objects are Pantene® shampoo cardboard cases that are 9.25″ tall and occupy a footprint of 7.5″×9.0″. Each case contains six 750 ml bottles of shampoo. Each layer includes twenty-six cases, and each pallet includes five layers. Thus, each pallet stack contains 130 cases of shampoo, or 780 bottles.

According to an embodiment, a boundary condition is that the RFID tags can be placed at any location on the exterior of the cardboard cases: top or sides.

The example test configurations described below may be applied to any waveguide. Thus, references will be made generally to waveguide 210, as described above with respect to FIGS. 2A and 2B.

In example embodiments, the waveguide 210 has a cost per unit less than $0.30 and is 1) disposable and recyclable, 2) sized for the US market (e.g., 40″×48″), 3) capable of a single configuration that works with >80% of tagged products, 4) able to provide an economic advantage over reading individual cases, and 5) able to provide 99.9% or better tag reads over 100 passes of 100% of products.

3.1 Testing the TE Mode Surface Waveguide Embodiment

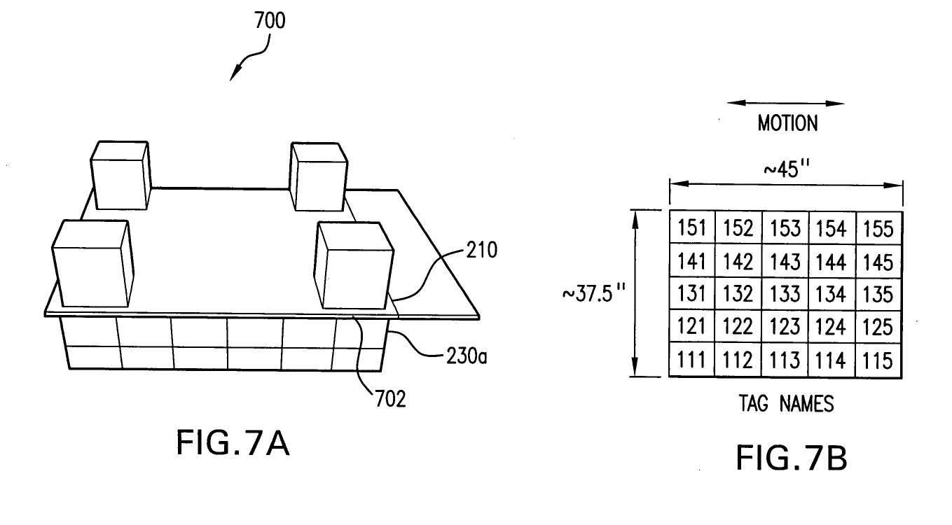

FIG. 7A shows a first example test configuration 700 for TE mode surface waveguide 500 shown in FIG. 5 according to an embodiment of the present invention. In the embodiment of FIG. 7A, layer 230a is 39″ wide and includes 26 cases. FIG. 7B shows a modified stacking pattern for configuration 700 according to an embodiment of the present invention. The modified stacking pattern of FIG. 7B allows more of waveguide 210 to be exposed to portal antennas, for example. In FIG. 7B, layer 230a includes twenty-five cases of Pantene® shampoo. As shown in FIG. 7B, layer 230a has a width of approximately 37.5″ and a length of approximately 45″.

In configuration 700, a white, ⅜″ thick foamboard 702 is placed between waveguide 210 and tags that are affixed to the cases in layer 230a to improve RF performance. Configuration 700 enables 24-25 of the 25 cases (i.e., 96-100%) in layer 230a to be reliably read.

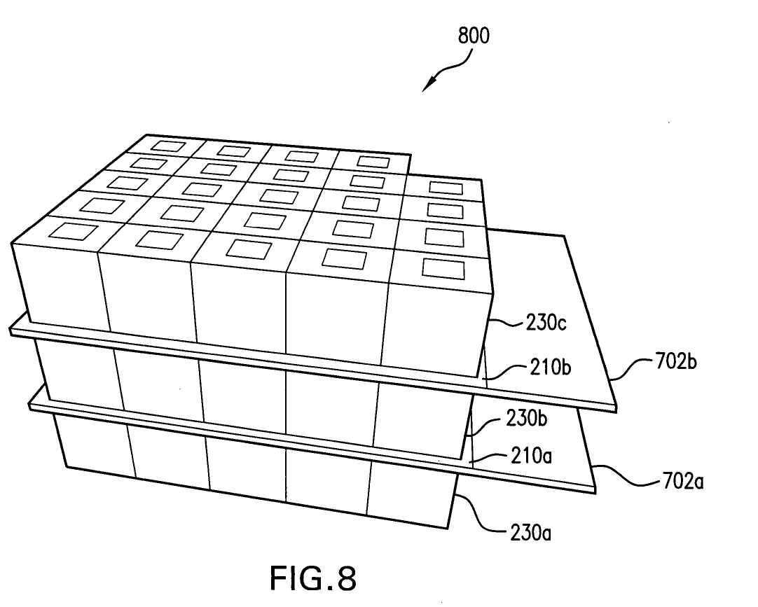

FIG. 8 shows a second example test configuration 800 for TE mode surface waveguide 500 shown in FIG. 5 according to an embodiment of the present invention. In the embodiment of FIG. 8, three layers 230a-c of Pantene® shampoo cases are tested. Each of layers 230a and 230b includes twenty-five cases, and layer 230c includes twenty-four cases. Waveguide 210a and foamboard 702a are between layers 230a and 230b. Waveguide 210b and foamboard 702b are between layers 230b and 230c. The proximity of Pantene® shampoo bottles in cases of layer 230b to the edge of waveguide 210a causes a degradation in RF performance, as compared to configuration 700. In an example test embodiment, configuration 800 enabled fifteen of the cases in layer 230a to be read, ten cases in layer 230b to be read, and all twenty-four cases in layer 230c to be read.

Following are six comments regarding the testing of TE mode surface waveguide 500 using configurations 700 and 800 as illustrated in FIGS. 7 and 8, respectively.

1. The TE mode surface waveguides 500 fabricated for these tests have significant metal losses. The excess series resistance for the capacitive frequency selective structure or surface (FSS), measured at RF frequencies, is approximately 2 Q per square. This is due to the finite resistivity of the conductive ink used in the silk-screening process. Different manufacturing methods may be used which may offer an order of magnitude improvement in resistivity, for example.

2. For a single-layer stack of Pantene® shampoo, the prototype TE mode surface waveguides 500 offered a 96% read rate. This is a very good result, especially in light of the losses in the FSS. When a second layer (i.e., layer 230b) of cases is added to the stack, the read rate fell to 15 out of 25 for layer 230a due to power absorbed by shampoo near the transition region.

3. Progressively thicker foam spacers between the FSS and the tags offer better read rates. For example, 4″ crossed dipole tags may be detuned when placed in close proximity to a TE mode surface waveguide 500. Tags designed for higher dielectric environments or different dielectric environments may be appropriate for this application.

4. One type of RFID tag was used in these initial experiments: a 4″ crossed dipole tag designed as an unloaded tag to be resonant near 915 MHz. Any of a variety of tags may be used. For example, simple dipoles, which offer more mounting options on the sides of cases, may be used.

5. The tapered slot transition region may be exposed as much as possible to provide maximum power transfer into the TE mode waveguide.

6. The forward link margin can be improved.

According to an embodiment, TE mode surface waveguides 500 are fabricated on (or affixed to) shelves or the sides or top of cardboard cases to guide RF energy from an RFID reader into a stack that includes the cases. In this embodiment, a discontinuity exists between TE mode surface waveguides 500 of adjacent cases. The discontinuity may limit power transfer from case to case, as compared to a larger, rigid waveguide that fits between horizontal layers of a stack. In embodiments, such as FIG. 2B, which has larger, rigid waveguides 210, discontinuities are reduced to only two: the transition at the edge of the pallet, and the actual coupling of waveguide fields into a tag 100.

3.2 Testing the Parallel Plate Waveguide Embodiment

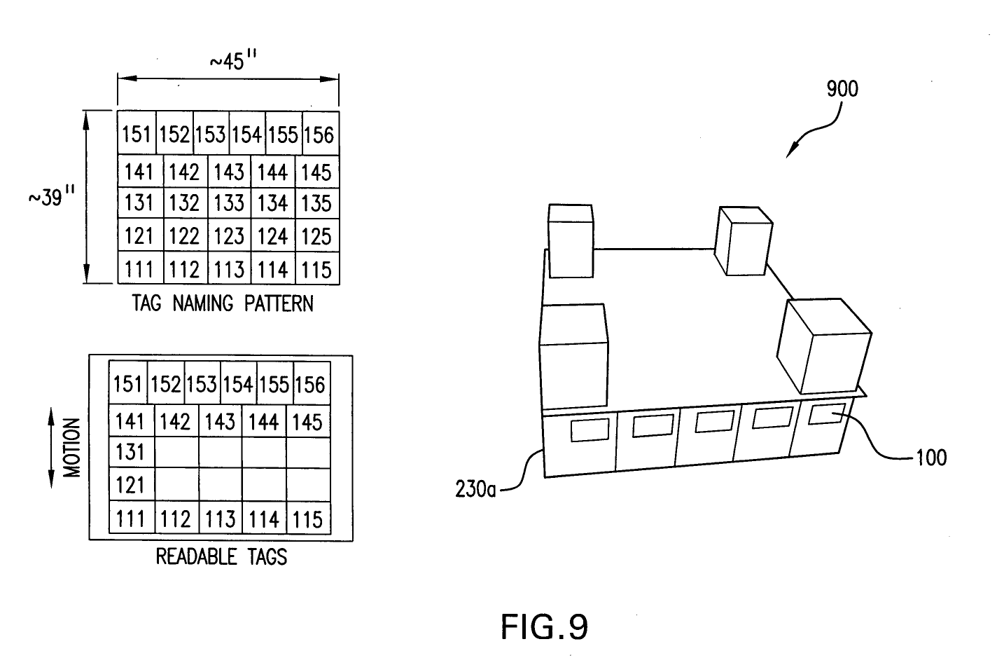

FIG. 9 shows an example test configuration 900 for parallel plate waveguide 600 shown in FIG. 6 according to an embodiment of the present invention. In the embodiment of FIG. 9, each case in layer 230a has a 4″ crossed dipole tag 100 affixed to its side. During an example test, configuration 900 enabled eighteen of the twenty-six tags 100 in layer 230a, including one entire row of interior tags 100, to be reliably read.

### 4.0 DIELECTRIC MATERIAL MEASUREMENTS

Given the large number of potential design variables for a waveguide, numerical simulation tools may be used to accelerate the design process. One design variable that is used in the simulation of a waveguide approach is the nature of the lossy dielectric. For example, measurements may be made of the lossy dielectric and provided to a simulation tool to facilitate designing the waveguide.

The dielectric used in the tests described herein is Pantene Pro-V® shampoo. Damaskos, Inc. of Concordville, Pa. was commissioned to conduct dielectric measurements of the Pantene Pro-V® shampoo. The measurements were performed over a broad frequency range, extending approximately one decade above and one decade below the RFID band, because the measurements were to be used in broadband time domain simulations.

A three-pole Debye model, as provided in Equation 1, can be applied to the measured data. The procedure he used is found in his dissertation. In the Debye model, frequency is given in GHz.

$$ɛ ( f ) = 12.5 - j \frac{3.59}{2 π {10}^{9} {ɛ}_{0}} + \frac{6.5}{1 + j ( \frac{f}{0.4} )} + \frac{8.8}{1 + j ( \frac{f}{1.6} )} + \frac{35}{1 + j ( \frac{f}{15.5} )} \qquad \text{Equation 1}$$

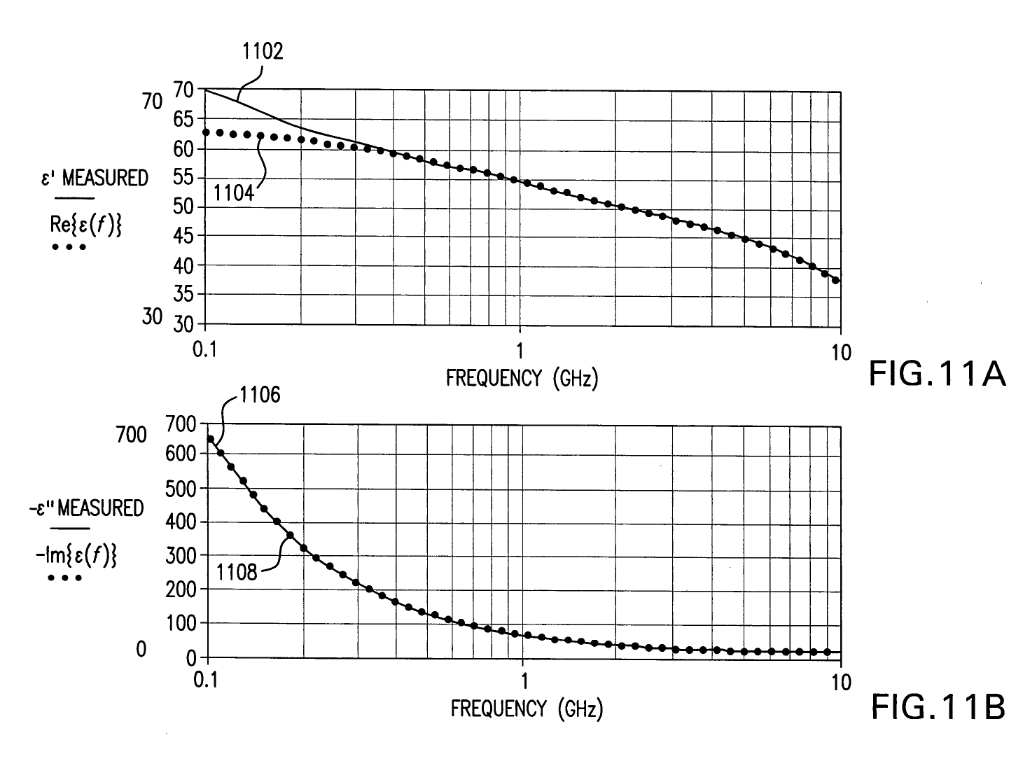

FIGS. 11A and 11B provide graphical comparisons between the measured data and modeled data for the real and imaginary parts, respectively, of the dielectric constant of Pantene Pro-V® shampoo according to embodiments of the present invention. In FIG. 11A, the measured real data is represented by solid line 1102, and the modeled real data is represented by dotted line 1104. In FIG. 1I B, the measured imaginary data is represented by solid line 1106, and the modeled imaginary data is represented by dotted line 1108.

Following are three example observations that may be drawn from the Debye model. First, the Debye poles are found at frequencies of 0.4 GHz, 1.6 GHz, and 15.5 GHz. For more economical numerical simulations, the highest frequency pole at 15.5 GHz may be ignored, because its contribution is more than a decade above the RFID band. According to the Debye model, the real part of the relative permittivity of the Pantene Pro-V® shampoo at an infinite frequency is 12.5, as indicated by the first term in Equation 1. A step change in permittivity of 35 can be added to the residual permittivity at infinity to reduce the number of poles associated with the Debye model. The step change speeds up the time required for simulation by approximately 30% because the evaluation time of a Debye material within Microstripes, for example, is proportional to the number of poles.

Second, the direct current (DC) conductivity is found from the second term of Equation 1 to be 3.59 S/m, which is very similar to seawater at 4.0 S/m. If this DC conductivity is ignored, the model will likely have errors in accuracy. As illustrated in FIG. 11B, the second term of Equation 1 causes ε″ (i.e., the imaginary part of the dielectric constant of Pantene Pro-Vs shampoo) to increase substantially as frequency goes to zero.

Third, the absolute value of both the real relative permittivity (ε″), as shown in FIG. 11A, and the imaginary relative permittivity (ε″), as shown in FIG. 11B, is quite high compared to corresponding values for air. For example, the relative permittivity of the Pantene Pro-V® shampoo is on the order of 55-j85 at a frequency of 900 MHz. A significant reflection occurs at 900 MHz for a plane wave incident upon a pallet stack of Pantene Pro-V® shampoo, as described in greater detail below.

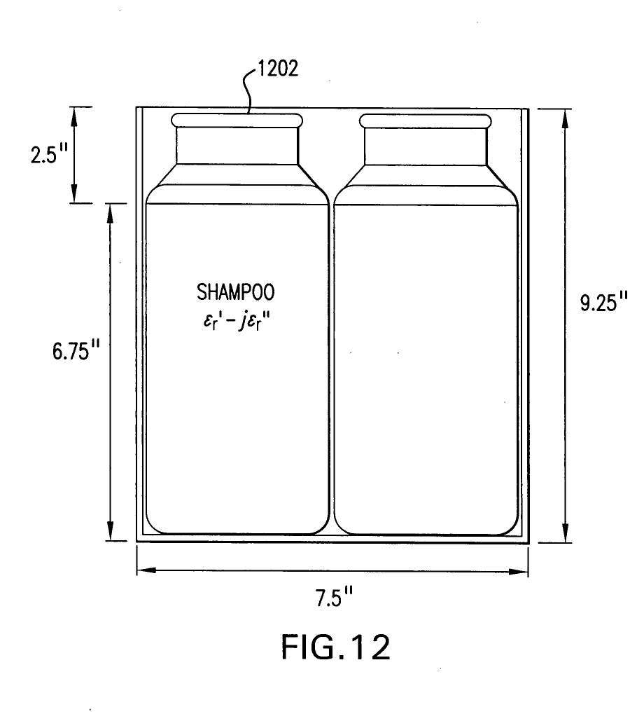

FIG. 12 illustrates the placement of 750 ml Pantene Pro-V® shampoo bottles 1202 in cases that were used for testing configurations 700-1000 described above with reference to FIGS. 7-10 according to an embodiment of the present invention. In FIG. 12, the top 2.5 inches inside the case is devoid of a lossy dielectric material. The bottles are approximately elliptic in cross-section with major and minor axes of 3.3″ and 2.85″, respectively.

### 5.0 CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for identifying objects, comprising:
a radio frequency identification (RFID) tag attached to an object in a stack of objects; and
a waveguide provided between objects in the stack to facilitate communication between an RFID reader and the tag.

2. The system of claim 1, wherein the waveguide is a TE (transverse electric) mode surface waveguide.

3. The system of claim 1, wherein the waveguide is a TM (transverse magnetic) mode surface waveguide.

4. The system of claim 1, wherein the waveguide is a parallel plate waveguide.

5. The system of claim 1, wherein the waveguide is an electromagnetic hard surface.

6. The system of claim 1, wherein the waveguide has an edge portion that extends beyond a perimeter of the stack.

7. The system of claim 1, wherein the waveguide is provided between vertical layers of objects in the stack.

8. The system of claim 1, wherein the waveguide is provided between horizontal layers of objects in the stack.

9. The system of claim 1, wherein the waveguide includes tapered metallic elements along an edge of the waveguide.

10. The system of claim 1, wherein the waveguide includes a first planar layer having a first plurality of metallic elements, a second planar layer having a second plurality of metallic elements, and a dielectric layer coupled between the first planar layer and the second planar layer; and wherein elements of the first plurality and elements of the second plurality partially overlap with each other.

11. The system of claim 1, wherein the waveguide includes an asymmetric stepped height transition at an edge of the waveguide.

12. The system of claim 1, wherein the waveguide has transition coupling slots at an edge of the waveguide.

13. The system of claim 1, wherein the waveguide has a slot through which radio frequency (RF) energy radiates to the tag.

14. The system of claim 1, wherein the waveguide includes interdigital capacitors.

15. The system of claim 1, wherein the waveguide includes overlay capacitors.

16. A method for identifying objects, comprising:
transmitting a first radio frequency (RF) signal to a waveguide that is provided between objects in a stack of objects; and
receiving a response signal from a tag that is affixed to an object in the stack.

17. The method of claim 16, further comprising:
processing the first RF signal to generate the response signal.

18. The method of claim 16, wherein transmitting the first RF signal includes transmitting the first RF signal to tapered metallic elements along an edge of the waveguide.

19. The method of claim 16, wherein transmitting the first RF signal includes transmitting the first RF signal in a direction that is normal to an electric field associated with the first RF signal.

20. The method of claim 16, wherein transmitting the first RF signal includes transmitting the first RF signal in a direction that is normal to a magnetic field associated with the first RF signal.

21. The method of claim 16, further comprising:
radiating the first RF signal from the waveguide to the tag via a slot in the waveguide.

22. A method for arranging objects for tracking, comprising:
(a) positioning a planar waveguide on a surface; and
(b) positioning objects on the planar waveguide to form a stack;
wherein the waveguide is capable of receiving a tracking signal and transmitting the tracking signal to reach the objects.

23. The method of claim 22, further comprising:
repeating at least one of steps (a) and (b) at least one additional time to add to the stack.
